(19) United States
(12) Patent Application Publication
(10) Pub. No.: US 2014/0283302 A1
(43) Pub. Date: Sep. 25, 2014

(54) Device for the insertion in bedsteads, bedding boxes or bed frames for use as a lying surface with a mattress on top of it for primarily a single person

(71) Applicant: Uwe Horstmann, Kanzach (DE)

(72) Inventor: Uwe Horstmann, Kanzach (DE)

(21) Appl. No.: 13/849,489

(22) Filed: Mar. 23, 2013

(51) Int. Cl. A61G 7/005; A61G 7/008

(52) U.S. Cl. CPC A61G 7/005; A61G 7/008
USPC 5/608; 5/607

(57) ABSTRACT

Device for insertion in bedsteads for use as lying surface with mattress on top. Prior art according to, e.g., German product testing institute Stiftung Warentest almost don't accomplish lying profile adaptation to human body as function of changing between supine or lateral position. This invention achieves said adaptation perfectly; furthermore its individual customisability is superior to prior art. Particularly people with deseases of spinal column, shoulder and hip joints will largely benefit. Device, lying surface for one person, has preloaded lever system and two independently from each other movable longitudinal halves, which in turn consist of always five elements. Four out of these five can significantly change their height resp. their tilt. By body turn into lateral position resp. onto mainly one longitudinal half, a body weight dependently adjustable limit load gets exceeded on this half so that it converts from upper into lower end position profile.

### CROSS-REFERENCE TO RELATED APPLICATIONS

I claim priority for this invention from a previous German patent application with the application number 10 2012 005 989.2 and the filing date Mar. 23, 2012.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Known as prior art on the market are sprung slatted bases, sprung slatted bases with resilient plates above, waterbeds, airbeds, and sprung edge divan bases resp. box spring bases. According to the German product testing institute Stiftung Warentest all of them don't make much for a favorable lying surface profile; in a mattress test report in their monthly magazine “Test” 2010/February they wrote, that an inelastic rollable duckboard mechanically performed nearly as well as expensive sprung slatted bases with resilient plates above. Using a mattress with a height of 20 cm, an effect of the device underneath could hardly be found. A waterbed test report in “Test” 2005/September concluded, that movements were impeded by a very deep sinking of the body, and that only heavy parts of the body sank deep, not those, which should do so. Special edition 97/May: The spine was formed in a wrong way by waterbeds. Other disadvantages of waterbeds are a very high weight, an excess width because persons must change their position by rolling, the need of heating the bed, missing aerial circulation, possible leakages, limited adjustability to a changing body weight since their stabilization isn't changeable, and usage of Cadmium, other heavy metals or organic plasticisers in the vinyl of water mattresses.

The devices known as prior art almost don't bring about lying profile adaptation as a function of a person changing between supine, lateral or prone position. These adaptations are just achieved insufficiently and almost merely by the mattress. Expensive viscoelastic foam mattresses, according to a report on viscoelastic mattresses in “Test” 2008/September didn't solve the problem. If the devices known as prior art formed a stress-relieved S-shaped spine in supine position, they would effect a hollow back and a back-bent head in prone position, and in lateral position a waist sinking too deep, a strongly pressure-loaded shoulder not sinking deep enough, and often an arm fallen asleep. In lateral position, the leg placed at the top disturbs the blood circulation of the leg placed below, and the bent knee of the leg placed above lies on a too low level in front of the leg placed below. This makes either the pelvis turn, resulting in a twisted spine, or the upper hip joint gets stressed unfavorably by inward rotation of the leg placed above, i.e., by the leg's rotation downward to the other side of the body.

An ideal level of the head in supine position would cause the head being placed too high in lateral position with the same pillow if at the same time the shoulder—impossible as to prior art devices—sank deep enough. But if the shoulder sank deep enough in lateral position, in supine position the shoulder girdle would sink too deep causing a hollow back and a too high head position. In lateral position the elbow and forearm of the lower placed arm are too lightweight to sink, while the shoulder of this arm sinks. Therefore either the depicted torsion of the spine gets amplified, or the joint of the lower placed shoulder is unfavorably stressed in a pulled-forward position.

Joints and spinal disks are insufficiently relieved by devices known as prior art and currently on the market. This way nightly regeneration is hindered and thus arthrosis and wear of the spinal discs are facilitated. These devices favor muscle tenseness since, by night, muscles have to work against malpositions.

An invention not found on the market with the IPC-Code A47C 31/12 follows, like the present invention, the basic idea that the prior art characteristic passive separate reaction of each lying surface area to a respective separate body part, is not sufficient. But A47C 31/12 comprises, in contrast to the current invention, pressure sensors, electric motors, and a controller.

### BRIEF SUMMARY OF THE INVENTION

The Prevention of the above-mentioned nightly malpositions of the human body is the key task of the “device for the insertion in bedsteads, bedding boxes or bed frames for use as a lying surface with a mattress on top of it for primarily a single person” with the elements and limitations of the independent claim 1 and further advantageous embodyments specified via dependant claims. The invention furthermore has to improve the lying comfort and shall be fully individually adaptable.

To achieve these aims, the invention provides prior art excelling, personally adaptable profile reshaping of the lying surface as a function of changes between supine position and lateral position. Supine- and lateral-position profile are individually adjustable partly independently from each other.

Reflections in advance on the invention: A person in supine position typically lies almost in the middle of his or her lying surface because otherwise in sleep he or she would fall out of the bed by turning into lateral position towards the closer longitudinal edge (longitudinal edge always means longitudinal edge of the lying surface). However, a human in lateral position almost lies on merely one longitudinal half (longitudinal half always means longitudinal half of the lying surface resp. of the device), with the spine relatively close to the longitudinal center line (longitudinal center line always means longitudinal center line of the lying surface), given a lying surface not narrower than 90 to 100 cm, because in that case after turning into lateral position the person has enough arm- and knee space towards the longitudinal edge without having to stem him- or herself more than some centimeters back towards the middle of the lying surface. Exceeding a lying surface width of 110 cm most people haven't to make this effort at all and therefore after rolling back into supine position they are roughly lying in the middle again.

Hence in supine position there are two imaginary longitudinal halves loaded by a person, however, in lateral position almost only one half.

The invention takes advantage thereof as on one of two independently from each other movable and to each other axis-symmetric longitudinal halves a pre-adjustable body weight dependent limit load is exceeded by turning into lateral position onto that half. Thus the surface profile of that half changes because there are subareas, in the halves, which can change their levels, each in another and determined manner, and thereby sink down from an upper to a lower end position.

### BRIEF DESCRIPTION OF THE SEVERAL VIEWS OF THE DRAWING

FIG. 1 View from above, lower end position of left longitudinal half and upper end position of right longitudinal half; FIG. 1 shows planes upon which sectional views U-U (FIGS. 6, 7), V-Y (FIGS. 10A, 10B), Z-Z (FIGS. 11A, 11B) are taken.

FIG. 2 View from above, upper end position of both longitudinal halves, sectional view of left longitudinal half

FIGS. 3A-3D Detail of FIG. 15A, four examples of individual lying surface profile pre-adjustment, effecting different heights of panels 5 and 4, and different angles of inclination of panels 5 and 4

FIG. 3A Medium height; castor wheels 12 in left end position effecting most downward tilt of waist area of chest panel 5

FIG. 3B High position; castor wheels 12 in medium position

FIG. 3C Medium height; castor wheels 12 in right end position effecting most upward tilt of waist area of chest panel 5

FIG. 3D Low position; castor wheels 12 in medium position

FIG. 4 Detail of FIG. 2

FIG. 5 View from above, upper end position of both longitudinal halves; FIG. 5 shows planes upon which sectional views T-T (FIGS. 16A, 16B), N-S (FIG. 9), M-M (FIG. 8), A-L (FIGS. 15A, 15B) are taken.

FIGS. 6 and 7 Main lever 30 actuated, corresponding to lower end position of one longitudinal half, caused by loading almost only this half with a person in lateral position

FIG. 6 Position of slide 36 (see FIG. 7) pre-adjusted to lightweight person

FIG. 7 Position of slide 36 pre-adjusted to heavy person

FIGS. 8 and 9 Main lever 30 not actuated, corresponding to upper end position of both longitudinal halves, caused by a person in supine position distributing her weight over both longitudinal halves

FIG. 8 Position of slide 36 pre-adjusted to lightweight person

FIG. 9 Position of slide 36 pre-adjusted to heavy person

FIG. 10A Side (sectional) view V-Y, head end-sided half

FIG. 10B Side (sectional) view V-Y, foot-sided half

FIG. 11A Side (sectional) view Z-Z, head end-sided half

FIG. 11B Side (sectional) view Z-Z, foot-sided half

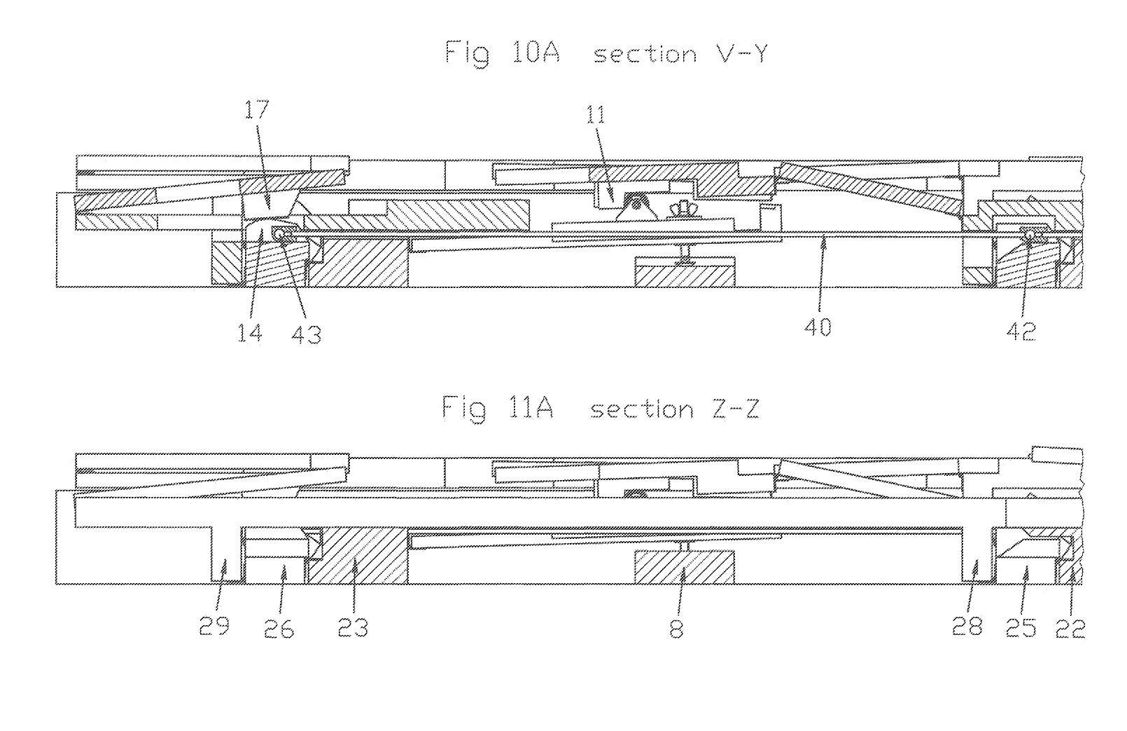

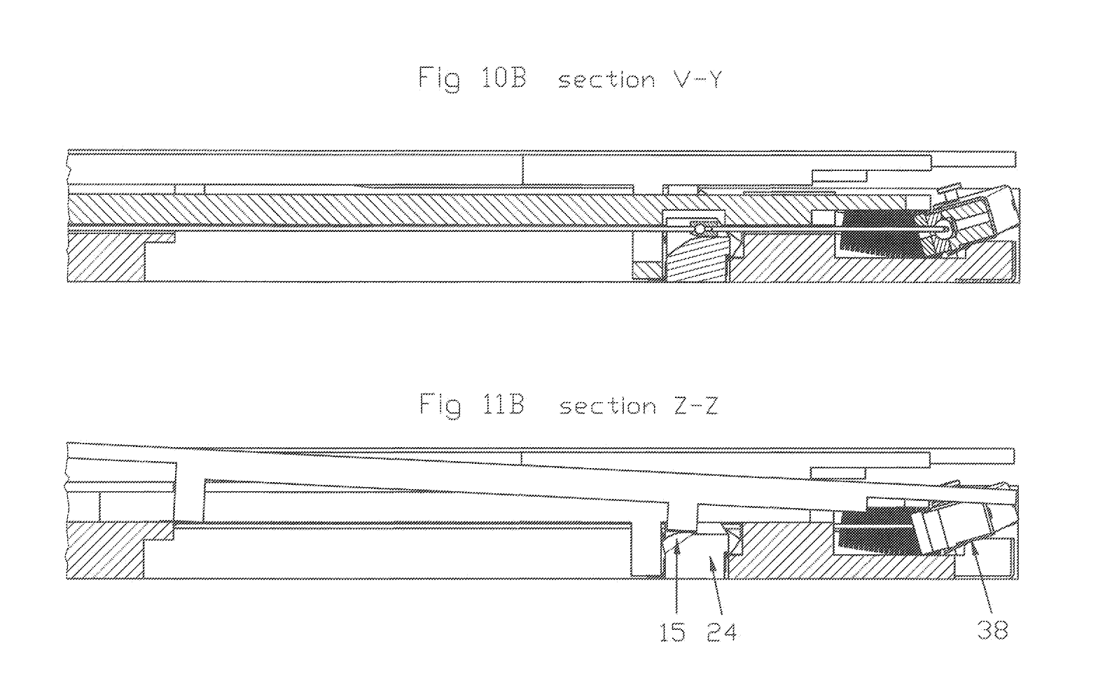

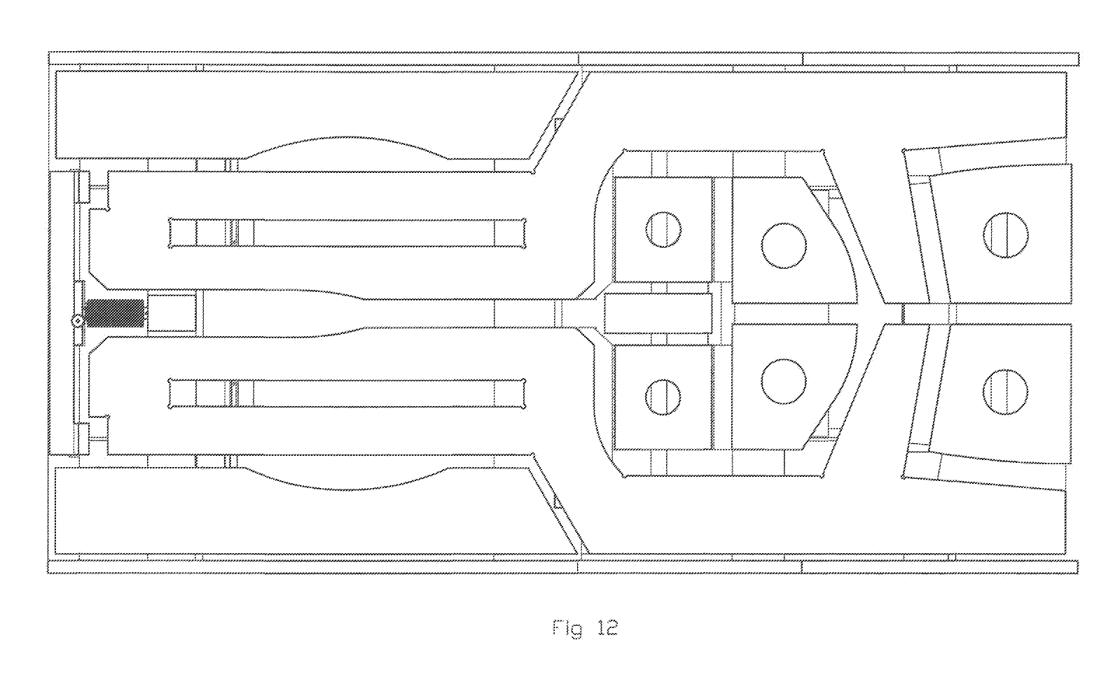

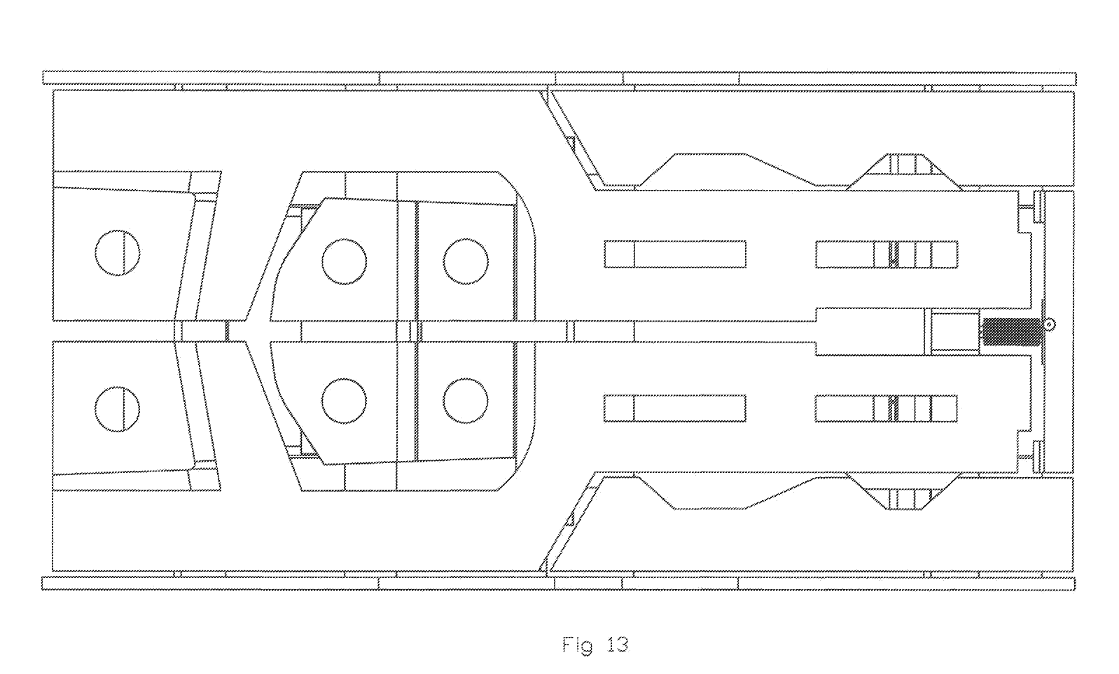

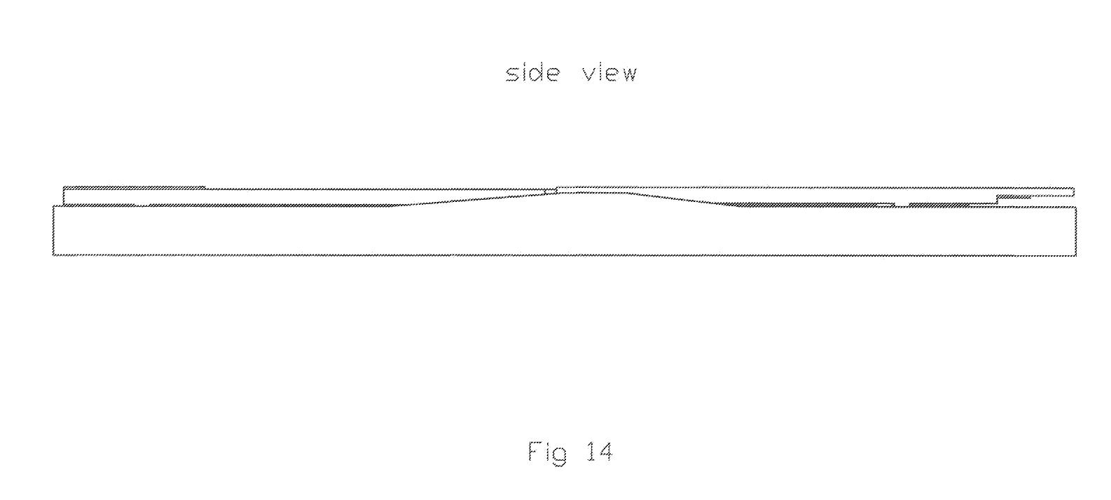

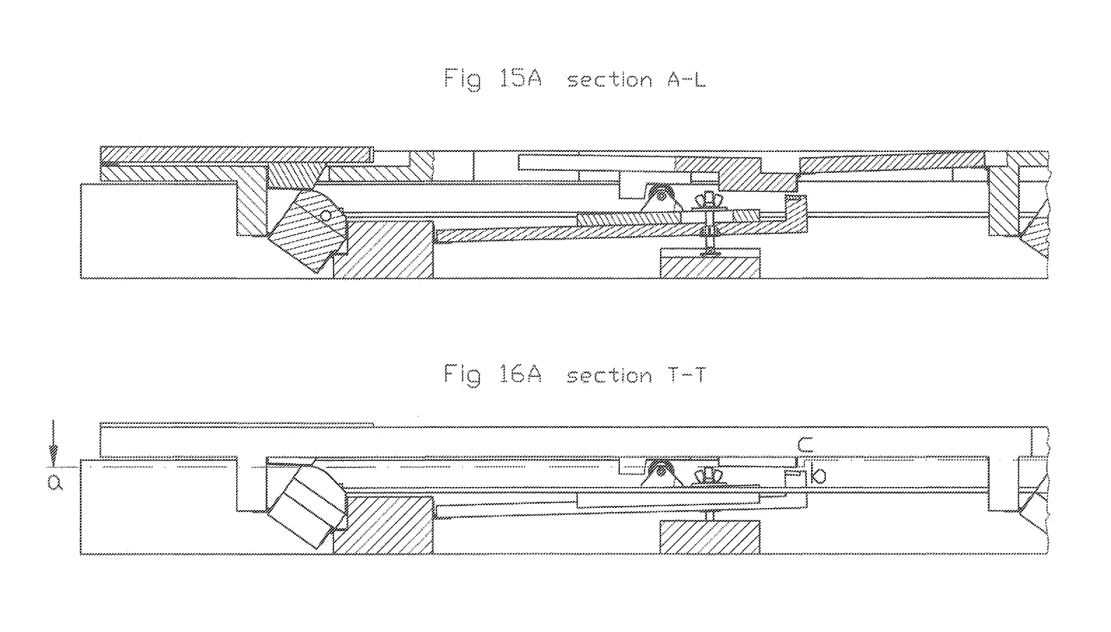

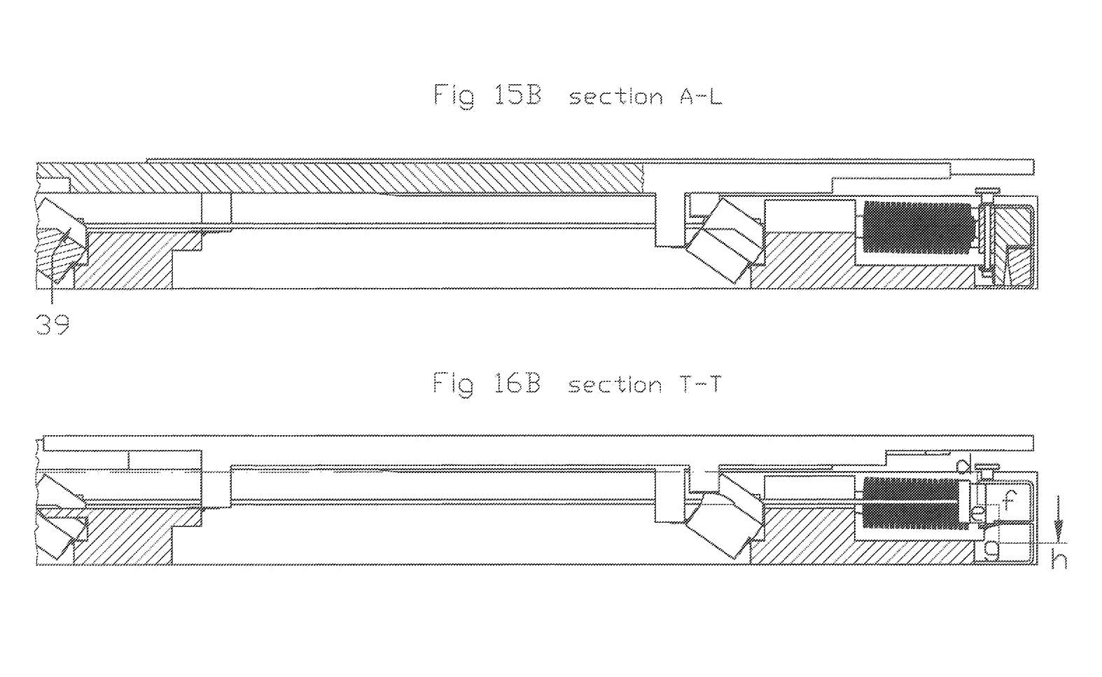

FIGS. 10A-11B In the foreground one longitudinal half in lower end position, in the background the other longitudinal half in upper end position

FIG. 12 Front Page View

FIG. 13 View from above, upper end position of both longitudinal halves

FIG. 14 Side view

FIG. 15A Side (sectional) view A-L, head end-sided half, upper end position

FIG. 15B Side (sectional) view A-L, foot-sided half, upper end position

FIG. 16A Side (sectional) view T-T, head end-sided half

FIG. 16B Side (sectional) view T-T, foot-sided half

FIGS. 16A, 16B Both longitudinal halves in upper end position

### DETAILED DESCRIPTION OF THE INVENTION

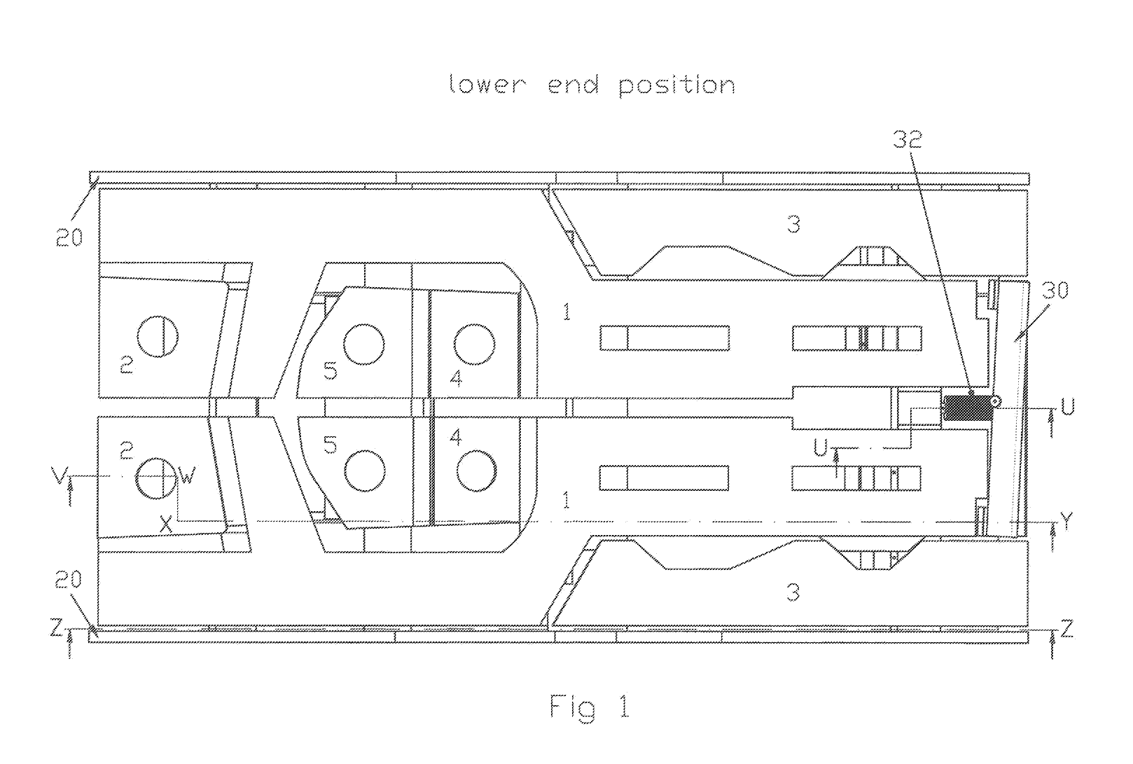

FIG. 1 shows the positions of the lying surface panels configuring the lying surface.

Description of One Longitudinal Half:

It consists of five panels with the reference signs 1, 2, 3, 4 and 5. The lying profile for supine position i.e., of the upper end position is nearly plane. The lying profile for lateral position, i.e., the lower end position, evolves from it as the head panel 2 sinks with its head end-sided end (“head end” always means the end of the device in the direction of the lying person's head), the pelvis panel 4 with its foot-sided end (“foot” always means the end of the device in the direction of the lying person's feet), the leg panel 3 with its foot-sided end, as the main panel 1 sinks without rotation and as at the same time the average level of the chest panel 5 remains roughly unchanged.

All subareas of the lying surface are separated from each other by gaps for aeration and action.

The main panel 1 is the lying surface for half the shoulder girdle and one leg in supine position and for the whole shoulder girdle, 1 to 2 arms and 4/3 to 2 legs in lateral position. It extends almost over the whole length of the lying surface, first less wide than half the longitudinal half from the head end to the hip region alongside of the longitudinal edge. Then in the lower hip region it changes to the longitudinal center line of the lying surface, alongside of which it extends nearly to the foot, about ⅗ as wide as the longitudinal half. In the shoulder region the main panel 1 has a broadening extending to the longitudinal center line.

Between the head end and the broadening of the main panel 1 there is the head panel 2 alongside of the longitudinal center line. Between the broadening of the main panel 1 and the lower hip region of the main panel 1 there are alongside of the longitudinal center line the chest panel 5 for the middle and lower chest and the pelvis panel 4 foot-sided of it. In lateral position, a person loads the head panel 2, chest panel 5 and pelvis panel 4 of the currently described one longitudinal half almost twice as much as in supine position—without importance to the chest panel 5, because it nearly can't change its medium level.

Alongside of the longitudinal edge in the leg region there is the leg panel 3 for the bent knee and the shank of the leg which is in lateral position the upper one and lying in front of the lower leg. During supine position usage the leg panel 3 is not loaded. The leg panel 3 has notches on the side of the longitudinal center line for better aeration and a better surface profile for the leg lying on it.

The head panel 2, The chest panel 5 and the pelvis panel 4 have each a respective cut-out for aeration. The main panel 1 has cut-outs for aeration in the leg region. Due to the human anatomy the ends of the foot-sided edge of the head panel 2 and of the head end-sided edge of the chest panel 5, which are closer to the longitudinal edge, are closer to the foot.

In FIG. 1 there are also the reference signs for the first time mentioned in the following paragraph.

On each side of the lying surface there is one respective rigid longitudinal member 20, about 2 cm broad in the topview (looking onto the lying surface). At the foot centered between the two leg panels 3 is the transversally mounted main lever 30. Next to it head end-sided between the two main panels 1 is the compression spring 32 and head end-sided of the latter is a base plate, which is part of the foot cross member 21 and contains a joint socket for one of the ball heads of the compression spring 32. The longitudinal member 20, the main lever 30, the compression spring 32 and the base plate are not covered by lying surface elements:

The leg panel 3 and the main panel 1 can move into the lower end position beside the longitudinal member 20, the main lever 30, the compression spring 32 and the base plate without colliding with these elements. So the device is built very flat which is an important criterion for its application in bedsteads, bedding boxes or bed frames.

Both longitudinal members 20 are rigidly fixed to one another by four cross members:

Foot cross member 21, hip cross member 22, shoulder cross member 23 and breast cross member 8, see also FIG. 11A. Six levers are fixed at the cross members 21, 22 and 23, always two levers at each of these cross members, each lever mounted by a hinge at the head end side of its cross member, every lever at the same height and of equal length, three levers in the right half and three levers in the left half of the device: Two foot levers 24 (see also FIG. 11B), two hip levers 25 and two shoulder levers 26. They are pivotable about transversal axes (“crosswise, crossing the device” or “transversal” always means horizontally crossing a person lying in normal direction on the bed).

Each element with the exception of the cross members and the main lever assembly group exists twice in one specimen of the invention because the device has a longitudinal vertical plane of symmetry—hereinafter only referred to as “plane of symmetry”. Therefore the following provides only a description of one longitudinal half.

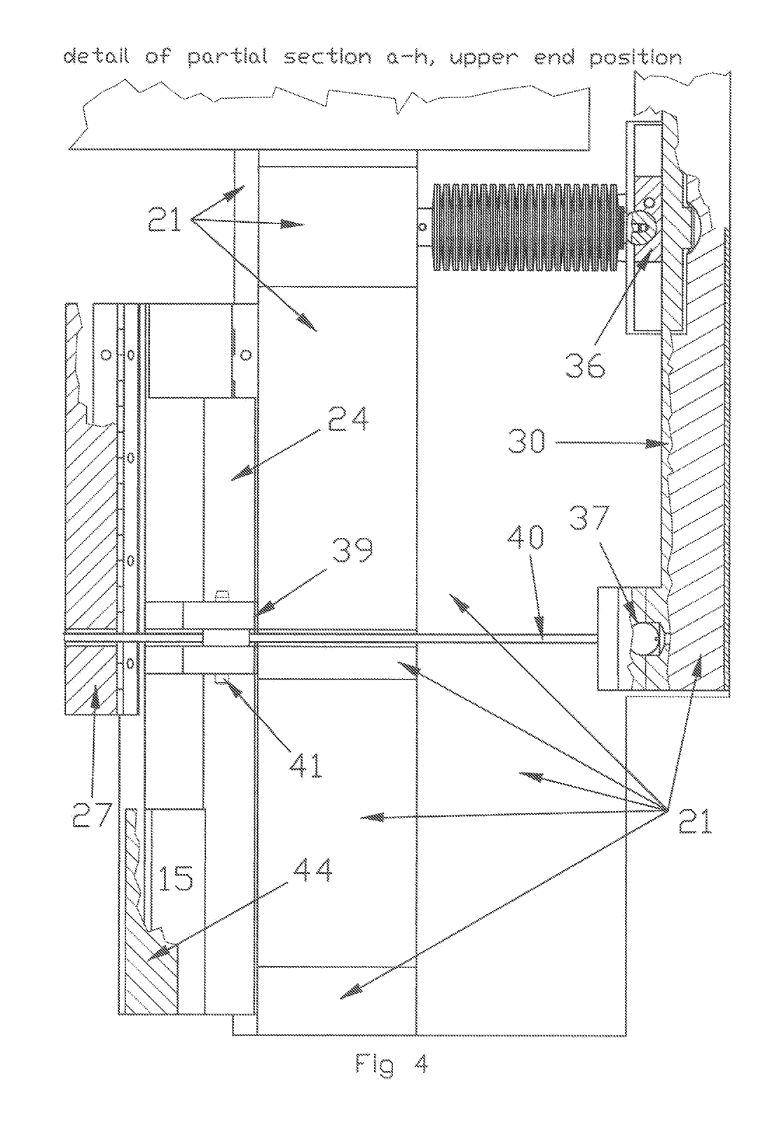

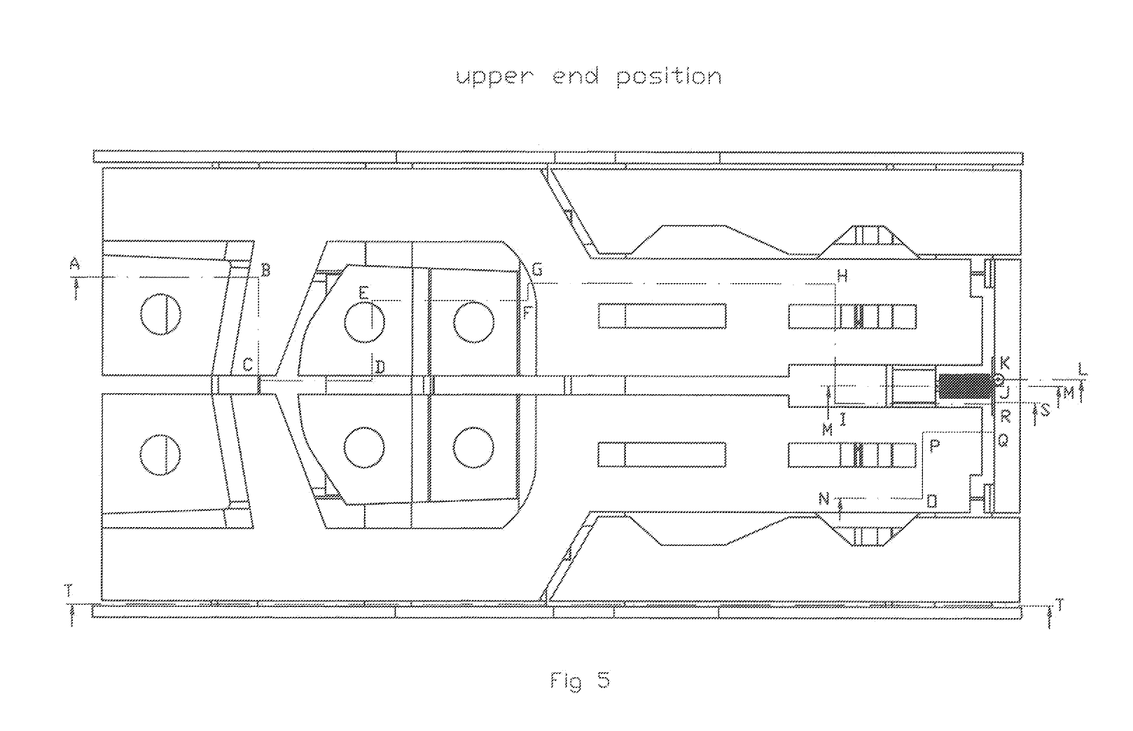

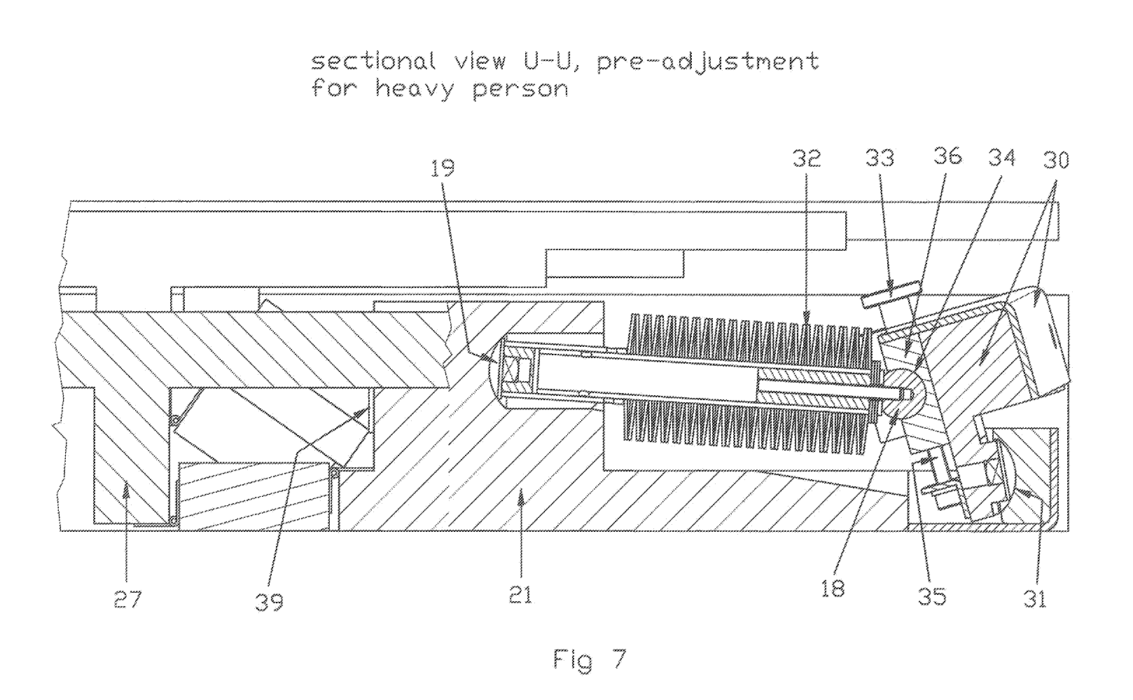

The reference signs for the first time mentioned are in the FIGS. 4, 7 and 11A unless other figures are mentioned explicitly.

A spacer is fixed pivotably about a transversal axis at the head end side of each of the levers 24, 25 and 26: A foot spacer 27 at the foot lever 24, a hip spacer 28 at the hip lever 25 and a shoulder spacer 29 at the shoulder lever 26. These spacers are rigidly fixed at the main panel 1, which is always horizontally on top of them. The foot lever 24, the hip lever 25 and the shoulder lever 26 have always one common rotary orientation. Their pivotal axes, by which they are connected with the cross members 21, 22 and 23, and by which they are connected with the spacers 27, 28 and 29, have all one common mean height, so that during the lifting and lowering of the main panel 1, i.e., during the turning of the levers 24, 25 and 26 between the end positions, there is almost no movement of the main panel 1 in the longitudinal direction of the device. Bigger horizontal movements of the main panel 1 would either cause friction forces between a lowering or lifting longitudinal half and the mattress or additional deformation resistance forces inside the mattress. Thus more force would be necessary so as to reach the upper or the lower end position of the longitudinal half—a critical factor for the proper functional reliability of the device. The upper end positions of the foot lever 24, the hip lever 25 and the shoulder lever 26 are determined by the upper stops 39, rigidly mounted at these levers (see also FIG. 15B), and by the upper stops, cams 14, see FIG. 10A. When the upper end position is reached, these upper stops push against the foot cross member 21, the hip cross member 22 and the shoulder cross member 23.

A special embodiment of the main panel 1 provides the pre-adjustability of the lift height of the main panel 1. In this case there are three vertical through-hole threads in the main panel 1, always one thread over the foot cross member 21, the hip cross member 22 and the shoulder cross member 23. Grub screws in the through-hole threads lessen the lift height, if they are screwed in so deep, that they protrude out of the bottom side of the main panel 1. Then in the lower end position it's not anymore the main panel 1, that lies on the cross members 21, 22 and 23, but the grub screws.

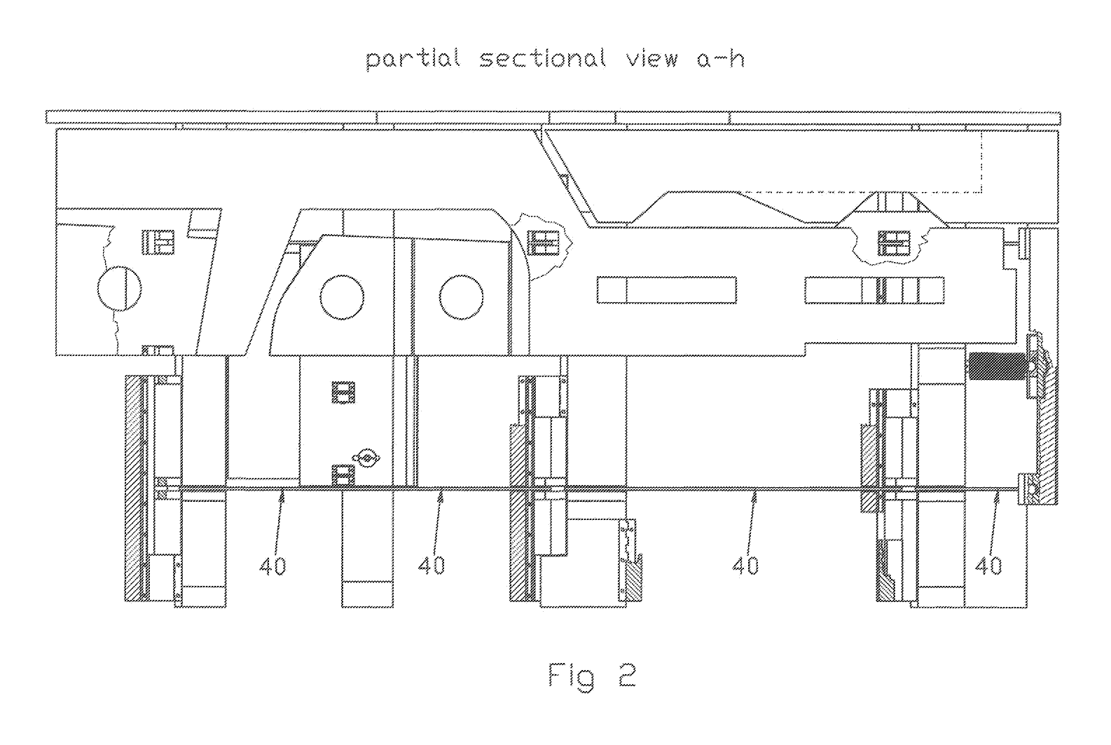

Under the main panel 1, there is always horizontal and parallel to the devices longitudinal axis an inelastic tensile element 40, advantageously a threaded rod (see also FIG. 2 and FIG. 10A). The tensile element 40 is connected by a rotary axis 41 with the foot lever 24, by a rotary axis 42 (see FIG. 10A) with the hip lever 25 and by a rotary axis 43 (see FIG. 10A) with the shoulder lever 26. The rotary axis 41 is nearer to the head end than the rotary axis, which connects the foot cross member 21 to the foot lever 24. The same—and also the same lever length—applies for the relationship of the rotary axis 42 and the rotary axis between 22 and 25 resp. of 43 and the rotary axis between 23 and 26.

The more the main panel 1 is lifted into the direction of the upper end position, the longer becomes the horizontal route section covered by the tensile element 40 versus the vertical route section. The tensile element 40 is triaxially pivotable connected to one end of the main lever 30, favorably by a ball joint 37.

At the foot is the main lever 30. It's exactly oriented crosswise and centric to the plane of symmetry, if both longitudinal halves are in the upper end position. It's mounted on top of the foot cross member 21. At its foot-sided lower area the main lever 30 is connected to the foot cross member 21 by a ball joint 31 in the plane of symmetry. When one of the two longitudinal halves which are in the upper end position, is sinking into the lower end position, the main lever 30 is pivoting simultaneously about two axes that are crossing the middle of the ball joint 31: About the transversal rotary axis h and the rotary axis k, wich is pivoting about the rotary axis h in the plane of symmetry. To the left and to the right of the plane of symmetry there is, rigidly fixed on top of the foot cross member 21 and as a support for the main lever 30, one respective cylinder surface segment 38 of one and the same cylinder (see also FIG. 11B). The related cylinder axis is the transversal rotary axis h. The main lever 30 has at both of its ends one respective plane surface lying on always one of the cylinder surface segments 38. When actuating the main lever 30, these plane surfaces slide on the cylinder surface segments 38. In this way additional degrees of freedom for the movements of the main lever 30 are suppressed.

In the plane of symmetry a compression spring 32 with a ball head at each end, space-saving as a column of disc springs according to DIN 2093, pushes with its foot-sided ball head 18 against the main lever 30, into the foot direction. The head end-sided ball head 19 of the compression spring 32 is seated in a joint socket in the foot cross member 21. The application point of the ball head 18 on the main lever 30 is located on a lever K. K is identical to the aforementioned rotary axis k and therefore equally pivotable about the aforementioned transversal rotary axis h. The ball joint 31 is closer to the foot than the ball head 18 and always below the extended line of the compression spring force vector, which crosses the center of the ball head 18. In contrast, an imaginary connecting-line between the two ball joints 37 is always above this force vector. Therefore the compression spring 32 is tensioned by the two tensile elements 40 and the ball joint 31.

The height of the application point of the ball head 18 on the lever K is pre-adjustable by changing the height of the ball joint socket 34 of the ball head 18 on the main lever 30.

Advantageous embodiment: A round rod 35 with a rotary handle 33 at its upper end is vertically and only rotatably mounted at the main lever 30. Its rotary handle is seated on top of the main lever 30. The threaded central section of the round rod 35 is outside the main lever 30 and screwed into the internal thread of the slide 36. The aforementioned ball joint socket 34 is in the slide 36. The slide 36 gets height-adjusted by turning the rotary handle 33. Thus the length of the lever K gets changed and the body weight (and personal preferences) dependent limit load pre-adjusted. A low position of the slide 36, corresponding to a lightweight person, requires less weight force for leaving the upper end position than a high position of the slide 36.

If, on one of the two main panels 1, the body weight dependent, pre-adjusted limit load is exceeded by turning from supine into lateral position, then this main panel 1 is, supported by the other body weight loaded, height-variable lying surface elements of the same longitudinal half, sinking from the upper into the lower end position by actuating that end of the main lever 30, which is on the same longitudinal half. Thereby the compression spring 32 is increasingly compressed and the concerned of the two ball joints 37 is performing an arc-shaped movement nearly identical to the movements of the rotary axes 41, 42, and 43. As a result there are almost no bending forces in the foot-sided section of the tensile elements 40 which thus can be space-saving threaded rods.

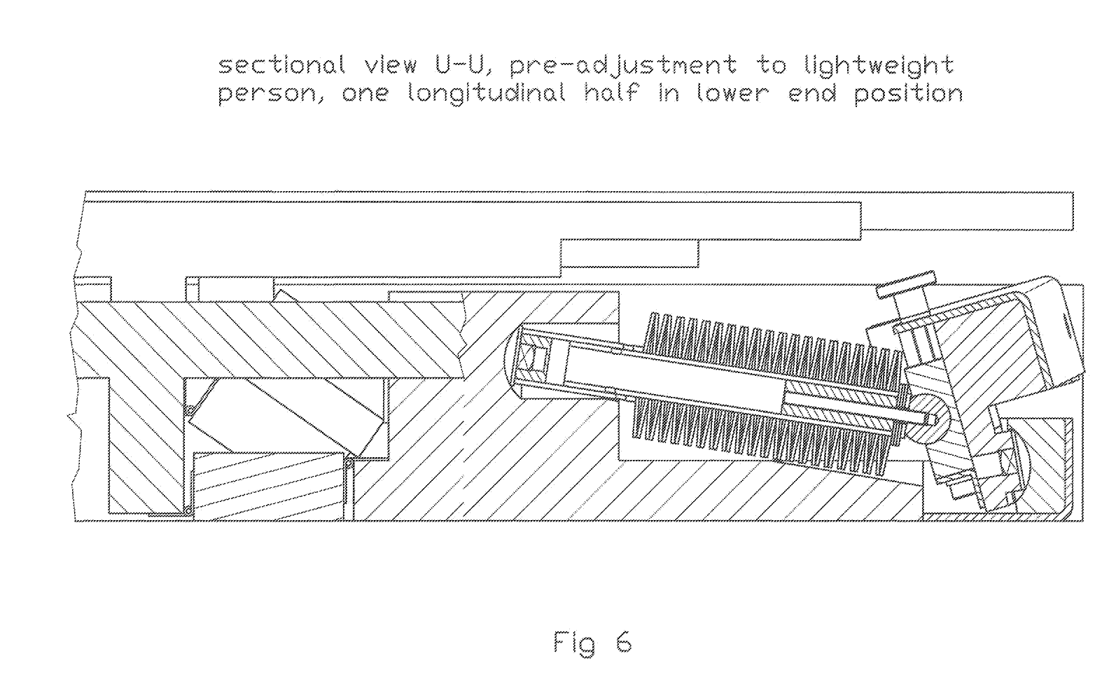

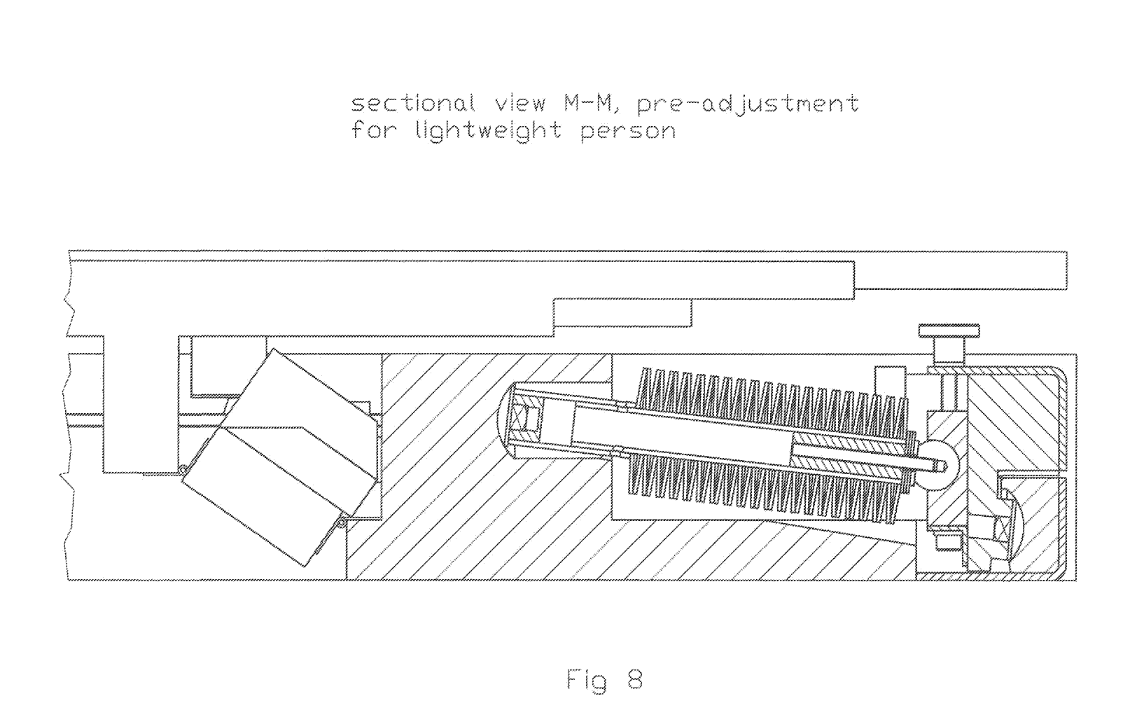

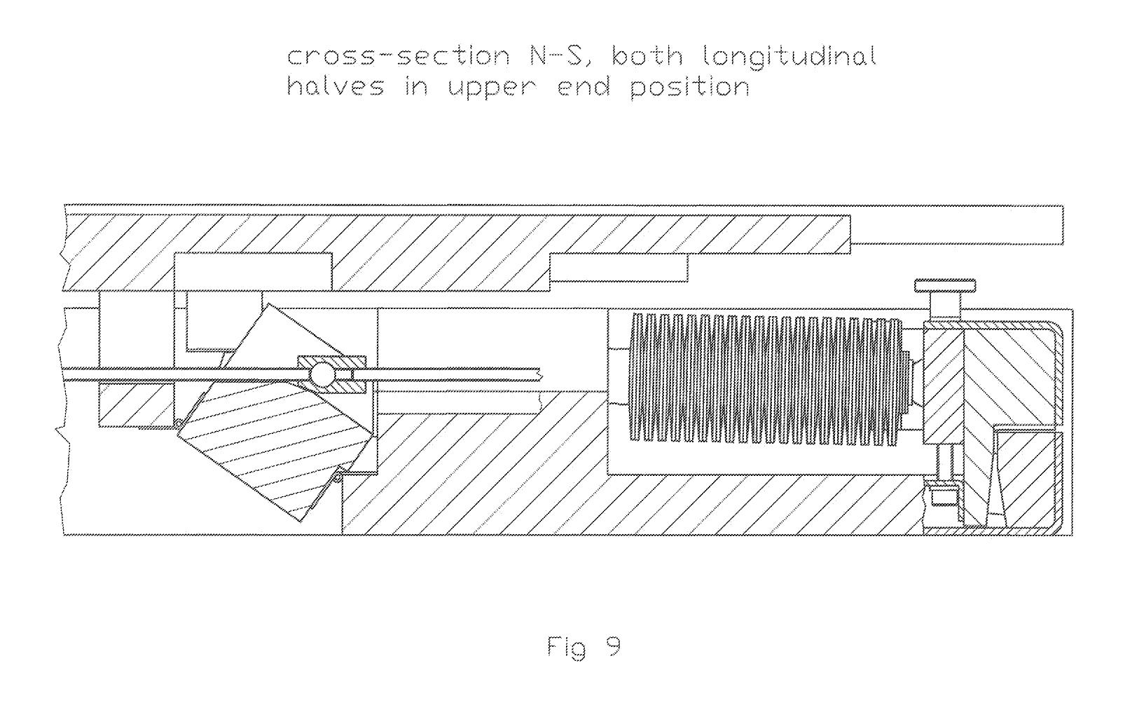

The FIGS. 6, 7, 8, and 9 show the main lever 30 actuated and not actuated with always two adjustments of the slide 36: one for lightweight persons and one for heavy persons.

The necessary pressing, by a person in lateral position, of a mattress into a lying surface profile underneath, which has the height differences appropriate for lateral position, leads, inside a mattress, to shear and flexural forces which set about 200 N against this moulding into an underlying profile, even if a high-quality cold-foam mattress is used. In order to make up for these forces, during the movement of a longitudinal half to the lower end position, the lever arm of the lever K is strongly shortening just like those lever arms of the foot lever 24, the hip lever 25, and the shoulder lever 26, which are constituted by the tensile element 40, whereas those lever arms of 24, 25, and 26, constituted by the main panel 1, aren't shortening. This change of the transmission ratio has a much stronger effect than the counteracting spring rate of the compression spring 32, and the resulting change of the transmission ratio on the way to the lower end position is referred to as degression in this specification. By means of the degression the increasing resistance of a mattress against the deformation of its underside on the way of one longitudinal half to the lower end position is compensated. Thereby is ensured that the lower end position resp. the lying surface profile for lateral position gets fully reached. In order to reach a high degression, the compression spring 32 has a low spring rate. When the body weight dependent limit load is getting pre-adjusted to a lower body weight, the degression thereby increases without any other adjusting element having to be manipulated. This increase of the degression is necessary because the absolute value of the degression depends among others on the product of the body weight and the degression factor, and because the absolute value of the degression has to offset the growth of a mattress' deformation resistance while the lying surface profile for lateral position is developing.

If a lightweight person uses the device, not only the degression factor but also the absolute value of the degression is the highest because lightweight persons have to get by with a low weight force difference (weight force difference: The difference between exceeding and deceeding the body weight dependent limit load on the height-variable lying surface elements of one longitudinal half, sufficient to move these elements from one stable end position to the other). By contrast, for a heavy person the absolute value of the degression is the lowest in order to avert hard collisions with the end positions. The degression fully offsets the deformation resistance of a mattress when the device is used by a lightweight person, but not when it is used by a heavy person.

What follows is the further description of the mechanics of one longitudinal half.

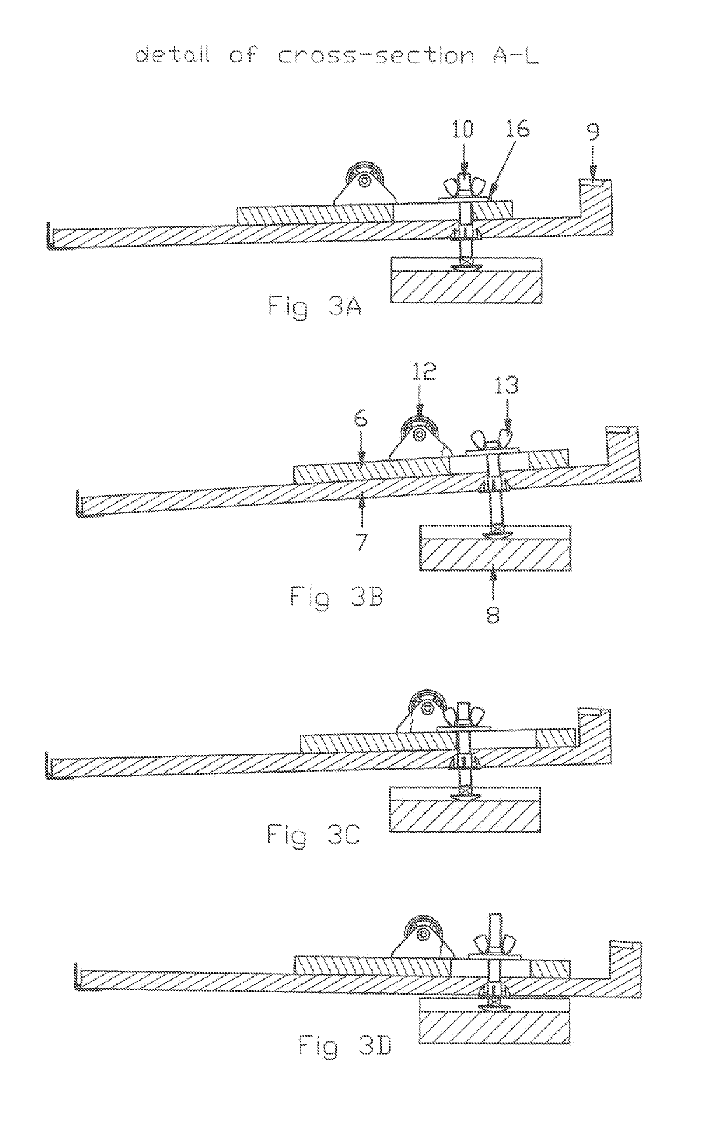

In FIG. 3A and FIG. 3B You will find the rest of the reference signs mentioned for the first time, unless other figures are quoted explicitly.

The chest panel 5 can perform little tilting movements under the trunk of a lying person, stirred by its body movements and favorable for its spinal column, by tilting around a transversal axis 6. In the figured embodiment the axis 6 is actually constituted by castor wheels 12 as the chest panel 5 and the axis 6 are shifting among each other in the longitudinal direction. The element named the axis 6 is a panel which supports the axis 6 resp. the castor wheels 12. You can see the castor wheels 12 also in the FIGS. 2, 10A, 15A, and 16A. The chest panel 5 is connected to the pelvis panel 4 by a transversal hinge. A plate 7 is, pivotably about a transversal axis, connected to the foot-sided edge of the shoulder cross member 23 and protrudes to the hip cross member 22. The plate which is referred to as the axis 6 is mounted adjustably in the longitudinal direction on top of the plate 7 by a parallel guide, by an elongated hole in the axis 6, by a through-hole thread in the plate 7 with preferably a carriage bolt referred to as screw 10 turned in from the underside, and by a nut 13 with a washer 16 for securing the position of the axis 6. The mean, i.e., the most likely angles of inclination of the chest panel 5 and the pelvis panel 4 while a person is lying on the device, get individually pre-adjusted via shifting the axis 6 longitudinally. The height of the axis 6 is pre-adjustable by turning the screw 10, the bottom end of which, protuding out of the underside of the plate 7, is resting on top of the chest cross member 8, see also FIG. 11A. The foot-sided edge of the pelvis panel 4 is, pivotably around a transversal axis, connected to the main plate one. Thus the pelvis panel 4 and the chest panel 5 are secured on their positions within the lying surface.

Above the foot-sided end of the plate 7 is an end position damper 9 with a special height adjustment: If the pre-adjusted height of the axis 6 changes, the mean angles of inclination of the chest panel 5 and the pelvis panel 4 shall change too. Thereby the angle of inclination of the swivel range changes, within which the mean inclinations of the chest panel 5 shall be. Hence the end position damper 9, limiting the downward pivoting of the foot-sided end of the chest panel 5, must get repositioned on the respective target limit of the new swivel range when the height of the axis 6 gets pre-adjusted. Hence the height adjustment of the end position damper 9 shall be the 1.5-fold value of the height adjustment of the axis 6. This is achieved because the axis 6 is placed on the plate 7 on two third of the way from the pivot axis of the plate 7 to the end position damper 9.

The following mean inclinations of the chest panel 5 and the pelvis panel 4 are the preferable default settings for supine position, dependent on the individual pre-adjustment of the height of the axis 6: When the chest panel 5, the pelvis panel 4 and the main panel 1 are at the same level, the mean inclinations of the panels 5 and 4 shall be zero, i.e., the horizontal position. When the chest panel 5 and the pelvis panel 4 are on a lower level than the main panel 1, the panels 5 and 4 shall on an average be inclined in such a manner that their deepest points are in the waist area and the head end-sided edge of the chest panel 5 shall be a bit lower than the main panel 1. When the chest panel 5 and the pelvis panel 4 are positioned higher than the main panel 1, only the edges of the panels 5 and 4 constituting the waist area of a person shall protrude over the level of the main panel 1. Examples for the pre-adjustment options regarding the heights and angles of inclination of the panels 5 and 4 are shown in the FIGS. 3A, 3B, 3C, and 3D.

Used in lateral position, the head end-sided edge of the chest panel 5 is placed lower than in supine position if the user prefers, in lateral position, to have his waist strongly elevated rather than to have his shoulder lowered very deep, which is more likely as to women; but it might also be wanted that in lateral position the head end-sided edge of the chest panel 5 is placed higher than the foot-sided edge, or even higher than in supine position. This is the case if the user prefers, in lateral position, to have his shoulder relatively lowered very deep rather than to have his waist strongly elevated, which is more likely as to men. In this case another feature of the invention applies: A stop element 11 (see FIG. 10A), adjustable in the longitudinal direction and head end-sided of the castor wheels 12, is fixed on the underside of the chest panel 5. The stop element 11 gets pre-adjusted so close to the castor wheels 12 that it collides with the castor wheels 12 before the lowering main panel 1 has reached the lower end position. The stop element 11 does collide because, while the main panel 1 is lowering, the tilt angle of the pelvis panel 4 enlarges, causing a movement of the chest panel 5 towards the foot. During the further sinking of the main panel 1 towards the lower end position the foot-sided end of the chest panel 5 is lowering since its further movement towards the foot is stopped by the stop element 11.

The pelvis panel 4 can be folded up into the vertical position and the chest panel 5 can at the same time be folded into the horizontal position directed towards the foot in order to enable the access to the screw 10, the nut 13 and the stop element 11. Over the main panel 1 lies, at the head end pivotably connected with the main panel 1 about a transversal axis, the head panel 2. Favorably, in the upper end position, the upper surface of the main panel 1 and of the head panel 2 are substantially offset-free via a recess in the main panel 1 underneath the head panel 2 so as to achieve a full integration of the head panel 1 into the lying surface, and an air gap between the main panel 1 and the head panel 2. Below the head panel 2 and near to its foot-sided edge, there are two cut-outs in the main panel 1 straight through which upper stops/cams 14, see FIG. 10A, which are rigidly mounted on the shoulder lever 26, support spacers 17 which are fixed at the underside of the head panel 2. An alternative embodiment of the spacer 17 is height-adjustable, so that the height of the foot-sided edge of the head panel 2 can get adjusted. While the main panel 1 and the head end-sided edge of the head panel 2 are sinking, the foot-sided edge of the head panel 2 is substantially kept at its level by the shoulder lever 26, the upper stops/cams 14 and the spacers 17. Thus, in lateral position, an upward-bending of the head to the upper, unloaded shoulder is prevented.

The knee of the leg which is in lateral position placed on top, bent and resting in front of the leg placed below, is due to the leg panel 3 resting on a higher positioned surface than the pelvis and the leg placed below. This largely prevents the rotation of the thigh of the leg placed on top, towards the half of the body placed below and so it prevents a rotation of the pelvis and this way a torsion of the spine. The leg panel 3 is near to its head end side pivotably about a transversal axis connected to the hip cross member 22. Near to the foot side of the leg panel 3, rigidly fixed on its underside, there is a spacer 44, see FIG. 4. It's supported by a cam 15, which is rigidly fixed on top of the foot lever 24, see FIG. 4 and FIG. 11B. Thereby the foot-sided edge of the leg panel 3 can sink to a lower end position and the leg panel 3 is thus enabled, to generate some of the weight force difference (see top of page 9). This is an advantage versus a rigid embodiment of the leg panel 3.

One problem related to the devices known as prior art is that a change of the lying position of a person does not necessarily generate such relative pressure changes under the respective parts of the body which could effect the intended height and tilt differences between lying surface elements. The invention solves this problem by its force transmission between the lying surface elements of a longitudinal half whereby these elements move in a determined relation to each other between the end positions, notwithstanding the share of the weight force difference of a person which is acting directly on each of the lying surface elements. Even the application of the whole weight force difference to any single, height variable lying surface element causes the change of the end position of every height variable lying surface element on the same longitudinal half. The shoulder arm area in lateral position does benefit most from this synchronisation: This part of the body needs its whole weight force just to curve the underside of the mattress downwards into a space, out of which the device's lying surface extensively retracts only driven by the partial weight force differences of other areas of the body. And besides, said extensiveness of the retraction allows large bending radii of the mattress' respective shoulder area, which reduce the deformation resistance in a way to allow the shoulder to sink deep enough. The shoulder arm area of the main panel 1 doesn't provide any counterpressure against the sinking shoulder arm area of the body until the lower end position is reached.

The part of the shoulder arm area of the main panel 1, on which the shoulder in lateral position is resting, lies between higher, neighboring lying surface panels: The head panel 2, the chest panel 5, and the adjacent main panel 1 of the other longitudinal half. Towards the longitudinal edge the shoulder arm area of a main panel 1 broadens and even closer to that edge there aren't any neighboring lying surface panels. Thereby the mentioned curving of the mattress' underside gets facilitated an the lower placed arm in lateral position can also sink, like the related shoulder does, because it's placed closer to the longitudinal edge where there aren't neighboring lying surface panels which could prevent the mattress from lowering. As a result, in lateral position the torsion of the spine and/or the pulling-forward of the lower placed arm towards the breast get prevented. This is not the case with the state-of-the-art devices since an arm is too lightweight to sink substantially into a mattress by its own weight or even to cause deflection differences between neighbouring springs of any kind under a mattress.

A special embodiment of the device has an axis 6 and a plate 7 which are cut through in the plane of symmetry. This enables the heights and the tilts of the chest panels 5 and the pelvis panels 4 to get separately pre-adjusted on each longitudinal half in order to support the treatment of scoliosis.

The upper stops 39 of the two foot levers 24 and the two hip levers 25 are identical to the components in which there are the two rotary axes 41 and the two rotary axes 42, and the two upper stops/cams 14 of the two shoulder levers 26 are identical with the components in which there are the two rotary axes 43. The invention can also be used without being inserted in bedsteads, bedding boxes, or bed frames.

On the invention, independently from weight and proportions of a person, its vertebral column in supine as well as in lateral position is bedded in a way that it shows an ideal stress-free, not sideways bended S-shape. On the invention, the spine muscles relax and the forces between the vertebrae are slight as compared to prior art. The invention achieves these aims by its ability to automatically reshape its lying surface depending on whether a person is in supine or in lateral position.

In lateral position, the spinal column doesn't bend sideways for the following three reasons:

1.) In strong contrast to the state-of-the-art devices, the waist is never bedded too low since it gets, in relation to other parts, actively lifted onto its lateral-position height.

2.) The lower placed shoulder is always embedded deep enough and much deeper than on the prior art devices, with the significant additional effect of lessening the load applicated to the shoulders.

3.) The head end-sided edge of the head-supporting area gets lowered so that the head is not bended sideways towards the higher placed shoulder although the lower placed shoulder is embedded uncommonly deep.

The other advantages of the invention for lateral position:

The blood circulation in the lower placed arm is improved and the arm will hardly fall asleep.

The spine gets barely twisted because of two reasons:

Firstly, the lower placed arm, rested in front of the chest, sinks considerably deeper than its weight would allow on a state-of-the-art device and so it can't turn the chest. This fact also lessens the load applicated to the shoulder joints since the lower placed arm which cannot sink together with the lower placed shoulder, leads to a turn of this loaded arm towards the chest and thus to an additional shoulder joint stress, on prior art devices.

Secondly, the knee of the leg on top, resting in front of the lower placed leg, is causing less turn to the pelvis, and that means also to the spine, because this knee is lying on an elevated position. Favorably for the hip joint of the higher placed leg, this elevated knee position also lessens the rotation of the higher placed leg towards the lower placed half of the body. Finally, because of the elevated knee position, the thigh of the lower placed leg must support less of the weight of the higher placed leg which improves the blood circulation in the lower placed leg.

A total of six parameters can individually get pre-adjusted from the upside of the device. The customized lying surface profile for supine position is pre-adjustable partially independent from that for lateral position. Asymmetric settings are feasible to support the treatment of scoliosis. By means of a rotary handle on top of the invention's foot, the body weight of the user is exactly pre-adjustable without having to remove the mattress, i.e., without a person testing the device having to get up out of the bed.

What I claim as my invention is:

1. A device for insertion in bedsteads, bedding boxes or bed frames and also for use without such insertion, with a lying surface for one person, with a head end and a foot-sided end, comprising: two longitudinal lying surface halves, each half comprising following lying surface elements: a main panel (1), a head panel (2), a pelvis panel (4), a chest panel (5), wherein each of said halves can change between an upper and a lower end position, wherein two halves in upper end position constitute a lying surface profile for supine position, wherein any of the two halves in the lower end position constitutes a lying surface profile for lateral position, wherein exceeding a limit load on one half due to to a position change of a lying person causes this half to move into the lower end position, wherein deceeding said load causes a half to move into the upper end position, wherein in the lower end position the main panel (1), the head end-sided edge of the head panel (2) and the foot-sided edge of the pelvis panel (4) are on a lower level compared to their upper end position levels and to the chest panel (5).

2. The device of claim 1, comprising: a main lever (30) loaded by a compression spring (32) which is counteracting the sinking towards the lower end position, wherein the main lever (30) and the compression spring (32) are symmetrical in relation to the median longitudinal plane of the device.

3. The device of claim 2, wherein the main panels (1) are neighboring each other in the shoulder region and in the leg region.

4. The device of claim 3, wherein each chest panel (5) is pivotably connected to one pelvis panel (4), wherein each pelvis panel (4) is pivotably connected to one main panel (1).

5. The device of claim 4, wherein the head panel (2) is rested above the main panel (1) and pivotably mounted at the head end-sided edge of the main panel (1).

6. The device of claim 5, comprising a transversal tilt axis which supports the chest panels (5) and about which the chest panels (5) can tilt.

7. The device of claim 6, wherein the transversal tilt axis is mounted adjustably in the longitudinal direction.

8. The device of claim 6, wherein the height position of the transversal tilt axis is adjustable.

9. The device of claim 6, wherein there are two separately from each other adjustable transversal tilt axes, one on each longitudinal half, enabling the heights and tilts of the chest panels (5) and the pelvis panels (4) to get pre-adjusted separately on each longitudinal half, for supporting treatment of scoliosis.

10. The device of claim 6, comprising: a plate (7) which head end-sided edge is pivotably linked to a cross member and on which the transversal tilt axis is mounted; further comprising an end stop, which limits the downward pivoting of the foot-sided end of the chest panel (5), wherein the end stop is mounted further away, on the plate (7), from the connection of the plate (7) to the cross member, than the transversal tilt axis.

11. The device of claim 6, comprising: a stop element (11), which is head end-sided of the transversal tilt axis and adjustably in the longitudinal direction fixed on the underside of each chest panel (5) and which can be adjusted so that it collides with the transversal tilt axis while the longitudinal half of the chest panel (5) on which the colliding stop element is mounted, is sinking into the lower end position.

12. The device of claim 1, comprising: two longitudinal members (20), rigidly and parallelly arranged by rigid cross members, wherein each main panel (1) is supported by, and connected pivotably about transversal axes with at least two levers, wherein these levers are furthermore pivotably connected to the same number of cross members; further comprising: one respective longitudinally tensioned, tensile element (40) under each longitudinal lying surface half, each tensile element (40) connected to its corresponding of the two ends of the main lever (30) by a ball joint (37) and pivotably mounted at the levers of its longitudinal half.

13. The device of claim 12, wherein the closer the main panel (1) comes to the upper end position, the bigger the horizontal displacement of the tensile element (40) becomes versus its vertical displacement.

14. The device of claim 12, wherein the medium tilting position of each lever between its cross member pivot point and its main panel pivot point is horizontal, so that longitudinal movements of the main panels (1) are restricted to a minimum.

15. The device of claim 12, wherein the leg panels (3) and the main panels (1) don't cover the longitudinal members (20), the main lever (30) and the compression spring (32) module, so that they can sink down onto the level of (20), (30), and (32) in order to reduce the installation height of the device.

16. The device of claim 1, wherein that end of the head end-sided edge of the chest panel (5) which is closer to the longitudinal edge of the lying surface, is closer to the foot, wherein, towards the longitudinal edge, the part of the main panel (1) broadens, which is between the head panel (2) and the chest panel (5).

17. The device of claim 1, comprising: two leg panels (3) substituting those leg area parts of the main panels (1) which are neighboring the longitudinal edges of the lying surface, wherein each leg panel (3) can change between the upper and the lower end position and wherein in the lower end position the foot-sided edge of the leg panel (3) is on a lower level compared to its upper end position level and to the chest panel (5).

18. The device of claim 2, wherein in the upper end position the compression spring (32) is pre-tensioned by upper stops which prevent the main panels from lifting above the upper end position.

19. The device of claim 2, wherein the main lever (30) is at the foot-sided end of the device, and the compression spring (32) head end-sided of it.

20. The device of claim 19, comprising a ball joint (31) in the plane of symmetry by which the main lever (30) is connected to a cross member, wherein the compression spring (32) has a ball head (18) by which it acts on the main lever (30), wherein the ball joint (31) is always below the compression spring force vector, wherein an imaginary connecting-line between the two ball joints (37) is always above this force vector, wherein an angle between the ball joint (31), the ball head (18) as the angle's vertex, and the other end of the compression spring is bigger than 90° and enlarges when one end of the main lever (30) is actuated towards the lower end position.

21. The device of claim 20, wherein in the plane of symmetry the main lever (30) is, by the ball joint (31), pivotable simultaneously about two axes that are crossing the middle of the ball joint (31), a transversal rotary axis h and a rotary axis k, wich is pivotable about the rotary axis h in the plane of symmetry, wherein the ball head (18) acts on the main lever (30) in the rotary axis k which thus constitutes a lever, wherein the main lever (30) is supported by an immovable cylinder surface segment (38) under each of its ends, the cylinder axis of which is the transversal rotary axis h, so that the segments prevent further degrees of freedom for the movements of the main lever (30).

22. The device of claim 20, comprising: a slide (36) containing a ball joint socket (34) for the ball head (18) and guided in the main lever (30), wherein the height of the application point of the ball head (18) on the rotary axis k is adjustable by changing the height position of the slide (36) in its main lever guide via a screw, thus changing the lever arm k for pre-adjusting the body weight.

23. The device of claim 22, wherein the angle between the ball joint (31), the ball head (18) as the angle's vertex, and the other end of the compression spring enlarges if the height position of the slide (36) in its main lever guide gets lowered, which effects, for lightweight persons, a stronger increase of the transmission ratio while coming closer to the lower end position, compared to heavy persons.

24. The device of claim 20, wherein the compression spring 32 is a column of disc springs which are according to DIN 2093 in the version C, with has the highest degression.
